(19) United States
(12) Patent Application Publication
(10) Pub. No.: US 2023/0253814 A1
(43) Pub. Date: Aug. 10, 2023

(54) POWER DELIVERY ARCHITECTURE USING AN INTERMEDIATE BUS CONVERTER WITH TARGET VOLTAGE TRACKING CAPABILITY

(71) Applicant: Intel Corporation, Santa Clara, CA (US)

(72) Inventors: Jagadish V. Singh, Bangalore (IN); Raghavendra Rao, Bangalore (IN); Rohit Parakkal, Bangalore (IN); Anoop Parchuru, Bangalore (IN)

(21) Appl. No.: 17/592,741

(22) Filed: Feb. 4, 2022

(51) Int. Cl. H02J 7/00; H02M 3/155

(52) U.S. Cl. CPC H02J 7/007182; H02M 3/155

(57) ABSTRACT

Systems, apparatuses, and methods may provide for power delivery circuit technology that includes a charger controller coupled to a battery output and an intermediate bus converter coupled to an adapter output, a system power input and the battery output, wherein the intermediate bus converter varies a voltage level of the system power input based on the battery output. In one example, the voltage level of the system power input is one or more of a percentage value or an absolute value greater than a voltage level of the battery output. Additionally, the charger controller may connect the battery output to the system power input in response to a turbo power event.

### TECHNICAL FIELD

Embodiments generally relate to power delivery. More particularly, embodiments relate to a power delivery architecture using an intermediate bus converter with target voltage tracking capability.

### BACKGROUND

Notebook computers and other battery-powered devices are more frequently being used in applications having relatively high-power demand. Conventional power delivery solutions in these systems may experience relatively high-power losses.

### BRIEF DESCRIPTION OF THE DRAWINGS

The various advantages of the embodiments will become apparent to one skilled in the art by reading the following specification and appended claims, and by referencing the following drawings, in which:

FIG. 1 is a schematic diagram of an example of a narrow voltage direct charging (NVDC) architecture;

FIG. 2 is a schematic diagram of an example of a hybrid power buck-boost (HPBB) architecture;

FIG. 3 is a schematic diagram of an example of a power delivery circuit according to an embodiment;

FIG. 4 is a schematic diagram of an example of an intermediate bus converter circuit according to an embodiment;

FIG. 5 is a flowchart of an example of a method of operating a power delivery circuit according to an embodiment;

FIG. 6 is a block diagram of an example of a performance-enhanced computing system according to an embodiment; and

FIG. 7 is an illustration of an example of a semiconductor package apparatus according to an embodiment.

### DETAILED DESCRIPTION OF EMBODIMENTS

In a battery-powered device executing, for example, a graphics intensive application, a processing unit (e.g., central processing unit/CPU, host processor, graphics processing unit/GPU, graphics processor, Neural processing Unit/NPU) may be permitted to execute at an operating frequency (e.g., turbo boost mode) that is higher than the rated operating frequency for relatively long periodic bursts. As will be discussed in greater detail, technology described herein realizes the benefit of both a narrow voltage direct charging (NVDC) architecture (e.g., battery supplementary mode and lower power losses on downstream VRs) and a hybrid power buck-boost (HPBB) architecture (e.g., lower associated losses in the charger) while using the full power available from the external power source such as an AC-DC (alternating current to direct current) adapter.

### NVDC Charger Architecture

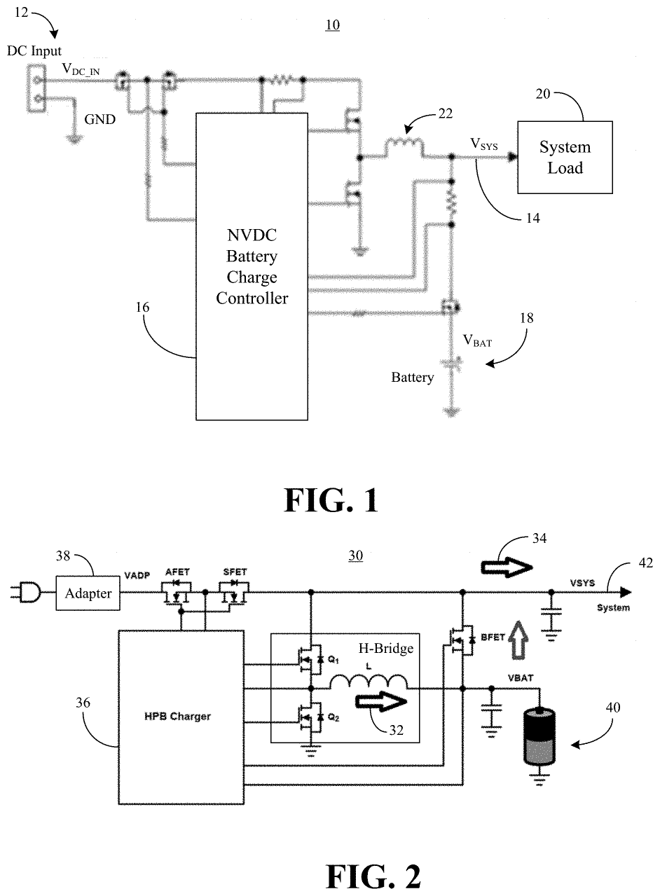

FIG. 1 shows an NVDC architecture 10 in which a DC (direct current) input 12 is provided by an external AC (alternating current) adapter (not shown). In the illustrated example, a system bus (Vsys) 14 is not connected directly to the adapter. Rather, the system bus 14 is connected to an NVDC battery charger, which operates only as a buck (e.g., step down) converter, both when 1) a controller 16 charges a battery 18 while providing power to the system through Vsys node and 2) when the battery 18 supplements the adapter to provide power to a system load 20. The NVDC architecture 10 reduces the switch-over period between the charging mode and the supplemental power mode. The NVDC battery charge controller 16 may also be implemented as a buck-boost (e.g., step down—step up) converter. The NVDC architecture 10 also allows the system to minimize the period of overloading the input power source when the CPU transitions into turbo boost mode.

An advantage of using the NVDC architecture 10 is that the downstream Power Delivery Network can be designed for a smaller voltage rating since the system has a lower range of input voltages (Vin). A disadvantage is that sizes of battery charger components and power dissipation increase due to both the system and battery being supplied power through an inductor 22 (e.g., therefore reducing end-to-end/E2E efficiency). Indeed, the component sizes may be too large for a high-powered laptop designed for application creators and gaming applications. The efficiency of the NVDC architecture 10 over the range of input voltages, 20V for the standard AC adapter and up to 48V in using an extended power range (EPR, e.g., Type-C adapter) AD adapter is shown in Table II below.

### HPBB Charger Architecture

FIG. 2 shows an HPBB architecture 30 having a charging power path 32 and a bypass power path 34 parallel to the charging power path 32. In the illustrated example, the charging power path 32 passes through a buck converter 36 (e.g., hybrid power buck/HPB charger) and an H-bridge by which an external adapter 38 provides power to charge a battery 40 (e.g., battery pack). Additionally, the adapter 38 provides power to a system power input 42 via the bypass power path 34.

An advantage of the HPBB architecture 30 over a traditional NVDC charger is that the losses in the battery charger section are greatly reduced due to the bypass power path 34. Therefore, the HPBB architecture 30 is a suitable topology for high-powered notebooks. The capacitors (not shown), however, on the input of the downstream voltage regulators (VRs) on the motherboard may be rated for the higher voltage of the adapter 38. Moreover, the larger input voltage range results in poor power conversion efficiency on the downstream VRs.

Additionally, when the power from the adapter 38 is insufficient for the system, the buck converter 36 operates in reverse boost mode, pumping the voltage from the battery 40 through the path 32 and Q1 (reverse boost). The battery 40 may therefore be used to supplement the power from the adapter 38. Though this approach involves adding only the bypass power path 34 to implement, the latency involved in supplementing power may be relatively high (e.g., ˜300 microseconds (μs)). Accordingly, turbo boost power durations less than ˜300 μs cannot be supported (e.g., negatively impacting system performance and responsiveness). In other words, the instantaneous power capability of the battery 40 cannot be utilized in certain circumstances. Based on the battery capacity, the amount of lost power and thus the lost performance may be significant.

In the case of traditional barrel jack adapters, some vendors support 1.5× the power capability for short durations of time (e.g., 10 milliseconds (ms)) with additional internal capacitance. With USB-C (e.g., Universal Serial Bus Type-C Cable and Connector Specification, Release 2.0, August 2019, USB Implementers Forum), there are options that can be exposed based on the supported higher power and the duration of time as shown in Table I. This approach may require additional internal capacitance, which increases cost and volume in the design of the adapter. On the other hand, providing this supplemental power from the battery 40 may be a better utilization of the available resources without any extra cost except for the latency aspect described earlier in reverse-boost mode.

TABLE I

| | Continuous | | |
|---|---|---|---|
| Adapter type | capability | Instantaneous capability | |
| Barrel Jack | I_{OC} (Operating | 1.5 × I_{OC} for 10 ms @ | |
| AC/DC adapter | current) | 9% duty-cycle | |
| USB-C PD | I_{OC} (Operating | 0 | I_{OC} |
| adapter | current) | 0 | |
| | | 0 | 1.5 × I_{OC} for 1 ms (5% dc) |
| | | 1 | 1.25 × I_{OC} for 2 ms (10% dc) |
| | | | 1.1 × I_{OC} for 10 ms (50% dc) |
| | | 1 | 2 × I_{OC} for 1 ms (5% dc) |
| | | 0 | 1. 5 × I_{OC} for 2 ms (10% dc) |
| | | | 1.25 × I_{OC} for 10 ms (50% dc) |
| | | 1 | 2 × I_{OC} for 1 ms (5% dc) |
| | | 1 | 1.75 × I_{OC} for 2 ms (10% dc) |
| | | | 1.5 × I_{OC} for 10 ms (50% dc) |

The efficiency of HPBB over the range of input voltage, 48 Vin using an extended power range (EPR) USB-C adapter is tabulated in Table II.

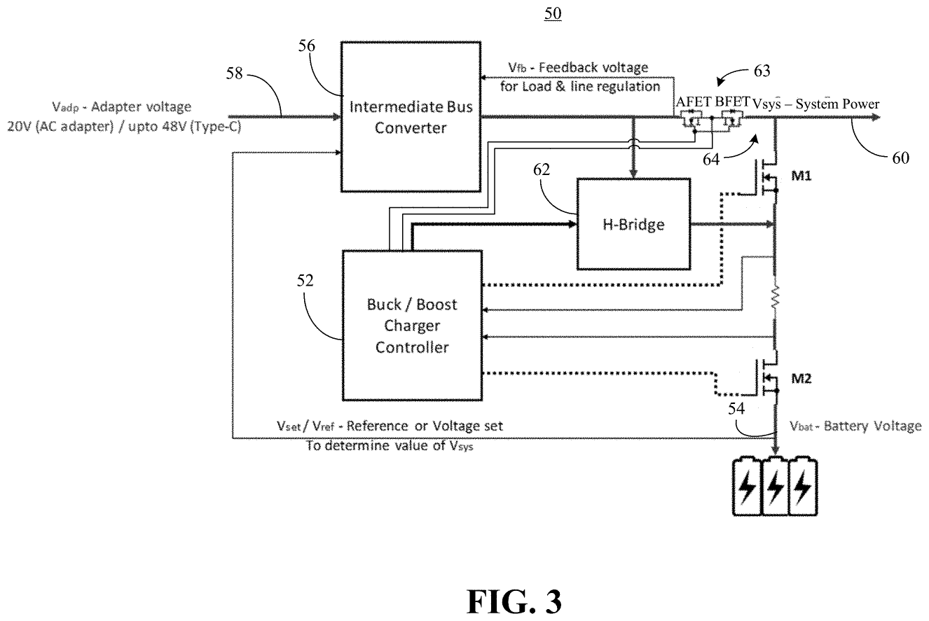

Turning now to FIG. 3, an enhanced power delivery circuit 50 provides the responsiveness and lower power losses on the downstream VR of an NVDC architecture along with the negligible losses on the charger as in the case of an HPBB architecture for systems having relatively high-power requirements. The circuit 50 achieves the best of both charger topologies without the respective disadvantages.

In the illustrated example, a charger controller 52 (e.g., HPBB charger with a modified controller) is coupled to a battery output 54 and an intermediate bus converter (IBC) 56 is coupled to an external adapter output 58 (e.g., EPR and/or standard power range (SPR) output), a system power input 60 and the battery output 54. As will be discussed in greater detail, the IBC 56 varies the voltage level of the system power input 60 based on the battery output 54. More particularly, the IBC 56 may ensure that the voltage at the system power input 60 is closer to the battery output voltage and one or more of a percentage value or an absolute value greater than the voltage level of the battery output 54. In an embodiment, the modified charger controller 52 connects (e.g., via field effect transistors (FETs) M1 and M2) the battery output 54 to the system power input 60 in response to a turbo power event (e.g., supplemental power mode). Thus, the charger controller 52 may be coupled to the battery output 54 via a charging power path through an H-Bridge 62, whereas the IBC 56 is coupled to the system power input 60 via a bypass power path 64. Additionally, the illustrated charger controller 52 results in an operation similar to NVDC mode where the voltage at the system power input 60 is maintained within a narrow voltage range.

Thus, a notable change is that the IBC 56 has a variable output voltage that tracks the battery output 54 (e.g., a separate node on the system). Traditionally, the output voltage is determined and fixed during the design phase. The change proposed is to set the output voltage of the IBC 56 to the system voltage, which based on the charging stages could be slightly higher than the battery voltage (e.g., value based on being in the constant current (CC) phase or the constant voltage (CV) phase).

In one example, the circuit 50 also includes a back to back (B2B) metal oxide semiconductor field effect transistor (MOSFET) pair 63, which may or may not be included based on the implementation. For example, if the adapters are expected to be always negotiated to a voltage higher than the battery voltage range, the B2B MOSFET pair 63 may be excluded. Rather, if lower input voltages are also expected to be supported, the B2B MOSFET pair 63 may ensure that the battery FET does not drain the battery voltage into the output of the IBC 56.

The circuit 50 therefore enhances performance at least to the extent that varying the voltage level of the system power input 60 based on the battery output allows the bypass of the charger implementation which increases the overall system efficiency while also reducing latency when the battery supplements the power supply due to the use of the BATFET path for power delivery instead of the reverse boost path. More particularly, the system power does not go through an inductor or switching FETs of the charger controller 52, as in the NVDC architecture. This reduces power loss in the system. The component sizes are also controlled (e.g., based on the charge-rate expectations in the design), with a lower PCB (printed circuit board) area requirement compared to an NVDC charger architecture meeting the same requirements.

Additionally, the battery power supplementing the power from the adapter occurs automatically, as the Vsys node is very close to the battery voltage. The switch M1 is turned on by the charger controller 52, after detecting a lower voltage on the Vsys line than that of the battery voltage. This operation enables an extremely fast response (e.g., low latency) as in the case of NVDC architecture.

In some implementations for the NVDC architecture, the M2 FET may be omitted. As already noted, the output voltage of the IBC 56 is close to the battery voltage. Accordingly, the losses associated with the circuit 50 are also relatively low when charging the battery.

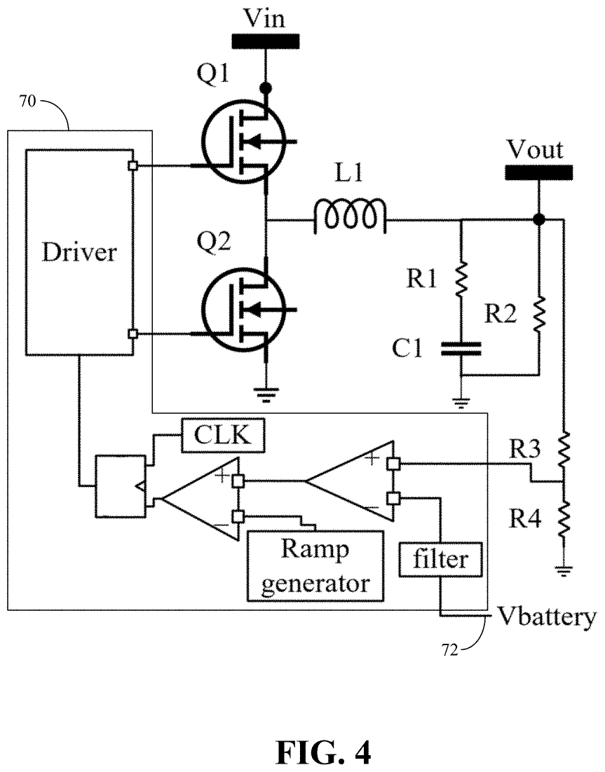

FIG. 4 shows one way of implementing an IBC 70. In the illustrated example, the sensed battery voltage 72 is used as the reference, post filtering. In an embodiment, a pre-programmed reference range also serves the purpose of limiting the output voltage (Vout).

The technology described herein provides the efficiency benefit of an NVDC system while operating with a HPBB charger based PDN (power delivery network) and also allowing battery supplementary mode of operation to respond to high turbo power events during operation.

Analysis of the three PDN architectures are discussed below.

NVDC system: System has three stages of power conversion
SCVR (switched capacitor voltage regulator) converting 48 Volts (V) to 24V (2:1);
NVDC charger converting 24V to 11.5V;
Downstream VR converting 11.5V to the appropriate voltages.

HPBB system: System has three stages of power conversion (two stages if the bypass on the charger is disregarded);
MLC (multi-level converter) converting 48V to 20V;
HPBB charger providing 20V through the bypass path;
Downstream VR converting 20V to the appropriate voltages.

Proposed solution: System has three stages of power conversion (two stages if the bypass on the charger is disregarded);
MLC converting 48V to close to battery voltage;
HPBB like charger providing the MLC output voltage (typically ˜11.5V) through the bypass path;
Downstream VR converting ˜11.5V to the necessary voltages.

Table II summarizes the power savings using the standard USB-C adapter with a 48V input voltage, an example IBC such as SCVR or MLC, the specific charger topology and INTEL Mobile Voltage Positioning (IMVP) as the downstream power conversion to generate core voltages for the silicon.

TABLE II

| Charger | | | E2E efficiency for | Total |
|---|---|---|---|---|
| Topology | PD configuration | Efficiency for each stage | system power delivery | Losses |
| NVDC | Adapter → SCVR (2:1) → | SCVR: 98.5% (24 Vout) | 81.34% | 32.5 W |
| Topology | NVDC (3S) → IMVP | NVDC: 94.20% | (Excluding the battery | |
| | | IMVP Efficiency: 87.5% | charging aspect) | |
| HPBB | Adapter → MLC → | MLC: 98.2% (20Vout) | 82.61% | 29.87 W |
| Topology | IMVP | IMVP Efficiency: 84.1% | (Excluding the battery | |
| | Adapter → Charger | Charger: 96% (for battery only) | charging aspect) | |
| New | Adapter → MLC → | MLC: 96.6% (11.5 Vout) | 84.66% | 25.71 W |
| Proposed | IMVP | IMVP Efficiency: 87.5% | (Excluding the battery | |
| topology | Adapter → Charger | Charger: 97% | charging aspect) | |

From Table II, NVDC topology with SCVR for the IBC has the lowest efficiency due to three stage conversion. This topology may not be a practical design for creator or gaming segments due to relatively high power and therefore higher power losses in the charger and in overall power conversion.

The HPBB topology suffers losses on the second stage of conversion due to the higher Vin and the switching losses associated. With the appropriate design of the IBC, the Vout of the IBC stage can be brought closer to the battery voltage (e.g., 14V), which would bring better efficiency but may or may not help in terms of battery supplemental mode depending on the duration of the instantaneous high-power requirement.

The proposed new topology offers the best efficiency (i.e., least power losses) and battery supplemental mode capability over the entire voltage range of the battery pack with suitable charger controller modifications. A multi-level converter (MLC) may be considered for the IBC. Though an MLC is considered, the implementation could be with a buck-boost or any other topology that can provide a regulated output voltage. Battery charging aspects may be disregarded as a common denominator to all the topologies.

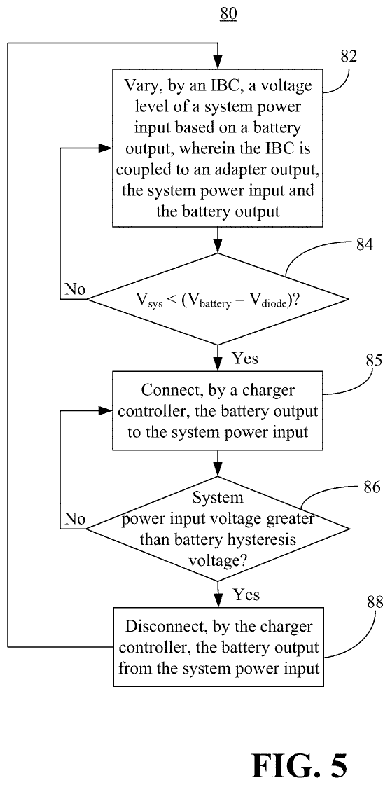

FIG. 5 shows a method 80 of operating a power delivery circuit. The method 80 may generally be implemented in a power delivery circuit such as, for example, the power delivery circuit 50 (FIG. 3). More particularly, the method 80 may be implemented in one or more modules as a set of logic instructions stored in a machine- or computer-readable storage medium such as random-access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic include suitably configured programmable logic arrays (PLAs), field programmable gate arrays (FPGAs), complex programmable logic devices (CPLDs), and general-purpose microprocessors. Examples of fixed-functionality logic include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

The illustrated processing block 82 varies, by an intermediate bus converter, a voltage level of a system power input based on a battery output, wherein the intermediate bus converter is coupled to an external adapter output, the system power input and the battery output. In an embodiment, the voltage level of the system power input is one or more of a percentage value or an absolute value greater than a voltage level of the battery output. A determination is made at block 84 as to whether the system power input voltage has fallen (e.g., drooped/dropped) below a voltage level of the battery output (e.g., the battery voltage minus the voltage drop of the body diode of the battery FET (BATFET) or V_{sys}<(V_{battery}−V_{diode}). Block 84 may therefore detect a condition in which the adapter is connected to the system and is not capable of providing turbo power (e.g., a turbo power event associated with the host processor). If so, block 85 connects (e.g., BATFET turn-ON), by a charger controller, the battery output to the system power input (e.g., in response to the turbo power event). In one example, the charger controller is coupled to the battery output via a charging power path and the intermediate bus converter is coupled to the system power input via a bypass power path. Additionally, the method 80 may operate the charger controller in an NVDC mode, wherein the charger is an HPBB charger (e.g., modified or unmodified).

Block 86 may determine whether the system power input voltage has exceeded a battery hysteresis voltage (e.g., V_{sys}>(V_{battery}+hysteresis)). If so, block 88 disconnects (e.g., BATFET turn-OFF), by the charger controller, the battery output from the system power input and the method 80 returns to block 82. If it is determined at block 84 that the voltage level of the system power input has not fallen below the voltage level of the battery output, the method 80 returns to block 82. Thus, block 85 is conducted whenever the voltage level of the system power falls below the battery voltage minus the voltage drop of the body diode of the battery FET (BATFET) or V_{sys}<(V_{battery}−V_{diode}). If it is determined at block 86 that the system power input voltage is not greater than the battery hysteresis voltage, the method 80 returns to block 85. The method 80 therefore enhances performance at least to the extent that varying the voltage level of the system power input based on the battery output increases efficiency while also reducing latency when the battery supplements the power supply.

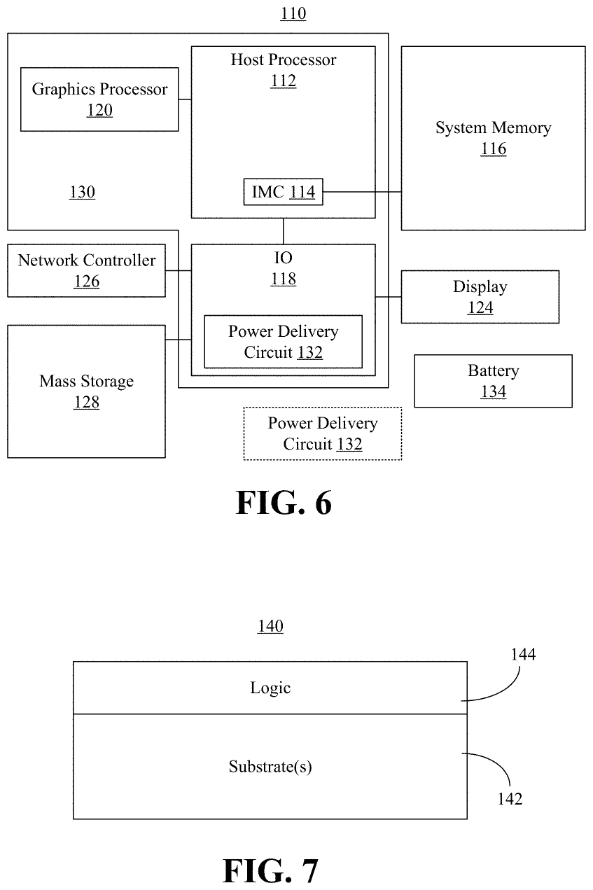

Turning now to FIG. 6, a performance-enhanced computing system 110 is shown. The system 110 may generally be part of an electronic device/platform having computing functionality (e.g., personal digital assistant/PDA, notebook computer, tablet computer, convertible tablet, server), communications functionality (e.g., smart phone), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot), Internet of Things (IoT) functionality, etc., or any combination thereof.

In the illustrated example, the system 110 includes a host processor 112 (e.g., CPU) having an integrated memory controller (WIC) 114 that is coupled to a system memory 116. In an embodiment, an IO module 118 is coupled to the host processor 112. The illustrated IO module 118 communicates with, for example, a display 124 (e.g., touch screen, liquid crystal display/LCD, light emitting diode/LED display), a network controller 126 (e.g., wired and/or wireless), and a mass storage 128 (e.g., hard disk drive/HDD, optical disc, solid-state drive/SSD, flash memory, etc.). The system 110 may also include a graphics processor 120 (e.g., graphics processing unit/GPU) that is incorporated with the host processor 112 and the IO module 118 into a system on chip (SoC) 130. The computing system 110 also includes a battery 134 that provides a battery output.

In one example, the IO module 118 includes a power management unit 132 that includes a power delivery circuit such as, for example, the power delivery circuit 50 (FIG. 3) and implements one or more aspects of the method 80 (FIG. 5), already discussed. Thus, the power management unit 132 may include a charger controller coupled to the battery output and an intermediate bus converter coupled to an adapter output, a system power input and the battery output, wherein the intermediate bus converter is to vary a voltage level of the system power input based on the battery output. As already noted, the voltage level of the system power input may be a percentage value and/or an absolute value greater than the voltage level of the battery output. Moreover, the charger controller may connect the battery output to the system power input in response to a turbo power event. The computing system 110 is therefore performance-enhanced at least to the extent that varying the voltage level of the system power input based on the battery output increases efficiency while also reducing latency when the battery supplements the power supply. Although the power delivery circuit 132 is shown in the IO module 118, the power delivery circuit 132 may reside elsewhere in the computing system 110.

FIG. 7 shows a semiconductor apparatus 140 (e.g., chip and/or package). The illustrated apparatus 140 includes one or more substrates 142 (e.g., silicon, sapphire, gallium arsenide) and logic 144 (e.g., transistor array and other integrated circuit/IC components) coupled to the substrate(s) 142. In an embodiment, the logic 144 includes a power delivery circuit such as, for example, the power delivery circuit 50 (FIG. 3) and implements one or more aspects of the method 80 (FIG. 5), already discussed.

The logic 144 may be implemented at least partly in configurable or fixed-functionality hardware. In one example, the logic 144 includes transistor channel regions that are positioned (e.g., embedded) within the substrate(s) 142. Thus, the interface between the logic 144 and the substrate(s) 142 may not be an abrupt junction. The logic 144 may also be considered to include an epitaxial layer that is grown on an initial wafer of the substrate(s) 142.

### ADDITIONAL NOTES AND EXAMPLES

Example 1 includes a performance-enhanced computing system comprising a host processor and a power delivery circuit coupled to the host processor, the power delivery circuit including a charger controller coupled to a battery output and an intermediate bus converter coupled to an adapter output, a system power input and the battery output, wherein the intermediate bus converter is to vary a voltage level of the system power input based on the battery output.

Example 2 includes the computing system of Example 1, wherein the voltage level of the system power input is to be one or more of a percentage value or an absolute value greater than a voltage level of the battery output.

Example 3 includes the computing system of Example 1, wherein the charger controller is to connect the battery output to the system power input whenever a voltage level of the system power input falls below a voltage level of the battery output.

Example 4 includes the computing system of Example 1, wherein the charger controller is coupled to the battery output via a charging power path.

Example 5 includes the computing system of Example 1, wherein the intermediate bus converter is coupled to the system power input via a bypass power path.

Example 6 includes the computing system of Example 1, wherein the charger controller is a hybrid power buck-boost (HPBB) charger.

Example 7 includes the computing system of Example 6, wherein the HPBB charger is to operate in a narrow voltage direct charger mode.

Example 8 includes the computing system of any one of Examples 1 to 7, wherein the adapter output is one of an extended power range output or a standard power range output.

Example 9 includes a power delivery circuit comprising a charger controller coupled to a battery output, and an intermediate bus converter coupled to an external adapter output, a system power input and the battery output, wherein the intermediate bus converter is to vary a voltage level of the system power input based on the battery output.

Example 10 includes the power delivery circuit of Example 9, wherein the voltage level of the system power input is to be one or more of a percentage value or an absolute value greater than a voltage level of the battery output.

Example 11 includes the power delivery circuit of Example 9, wherein the charger controller is to connect the battery output to the system power input whenever a voltage level of the system power input falls below a voltage level of the battery output.

Example 12 includes the power delivery circuit of Example 9, wherein the charger controller is coupled to the battery output via a charging power path.

Example 13 includes the power delivery circuit of Example 9, wherein the intermediate bus converter is coupled to the system power input via a bypass power path.

Example 14 includes the power delivery circuit of Example 9, wherein the charger controller is a hybrid power buck-boost (HPBB) charger.

Example 15 includes the power delivery circuit of Example 14, wherein the HPBB charger is to operate in a narrow voltage direct charger mode.

Example 16 includes the power delivery circuit of any one of Example 9 to 15, wherein the adapter output is one of an extended power range output or a standard power range output.

Example 17 includes a method of operating a performance-enhanced power delivery circuit, the method comprising varying, by an intermediate bus converter, a voltage level of a system power input based on a battery output, wherein the intermediate bus converter is coupled to an external adapter output, the system power input and the battery output, and connecting, by a charger controller, the battery output to the system power input whenever a voltage level of the system power input falls below a voltage level of the battery output.

Example 18 includes the method of Example 17, wherein the voltage level of the system power input is one or more of a percentage value or an absolute value greater than a voltage level of the battery output.

Example 19 includes the method of Example 17, wherein the charger controller is coupled to the battery output via a charging power path.

Example 20 includes the method of Example 17, wherein the intermediate bus converter is coupled to the system power input via a bypass power path.

Example 21 includes the method of any one of Examples 17 to 20, further including operating the charger controller in a narrow voltage direct charger mode, wherein the charger controller is a hybrid power buck-boost (HPBB) charger.

Technology described herein therefore provides higher overall efficiency in power conversion, through a charger (e.g., as in an HPBB architecture). Additionally, downstream VRs may be designed for only the NVDC voltage as input (e.g., as in an NVDC architecture). Moreover, the charger inductor may be sized only for battery charging (e.g., as in an HPBB architecture). In addition, there is minimal or no latency in battery supplementing AC power (e.g., as in an NVDC architecture, which is usually applicable to low power systems, but implemented for high power systems). The technology described herein also potentially lowers costs in the implementation of the power adapters and BOM (bill of material) components on the motherboard (e.g., such as implementing only a buck charger instead of a buck-boost charger) based on the design requirements in the system.

While the examples start with an HPBB charger modified to behave like an NVDC charger, the examples may also be implemented starting with an NVDC charger modified to behave like an HPBB charger.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A computing system comprising:
a host processor; and
a power delivery circuit coupled to the host processor, the power delivery circuit including:
a charger controller coupled to a battery output, and
an intermediate bus converter coupled to an external adapter output, a system power input and the battery output, wherein the intermediate bus converter is to vary a voltage level of the system power input based on the battery output.

2. The computing system of claim 1, wherein the voltage level of the system power input is to be one or more of a percentage value or an absolute value greater than a voltage level of the battery output.

3. The computing system of claim 1, wherein the charger controller is to connect the battery output to the system power input whenever a voltage level of the system power input falls below a voltage level of the battery output.

4. The computing system of claim 1, wherein the charger controller is coupled to the battery output via a charging power path.

5. The computing system of claim 1, wherein the intermediate bus converter is coupled to the system power input via a bypass power path.

6. The computing system of claim 1, wherein the charger controller is a hybrid power buck-boost (HPBB) charger.

7. The computing system of claim 6, wherein the HPBB charger is to operate in a narrow voltage direct charger mode.

8. The computing system of claim 1, wherein the adapter output is one of an extended power range output or a standard power range output.

9. A power delivery circuit comprising:
a charger controller coupled to a battery output; and
an intermediate bus converter coupled to an external adapter output, a system power input and the battery output, wherein the intermediate bus converter is to vary a voltage level of the system power input based on the battery output.

10. The power delivery circuit of claim 9, wherein the voltage level of the system power input is to be one or more of a percentage value or an absolute value greater than a voltage level of the battery output.

11. The power delivery circuit of claim 9, wherein the charger controller is to connect the battery output to the system power input whenever a voltage level of the system power input falls below a voltage level of the battery output.

12. The power delivery circuit of claim 9, wherein the charger controller is coupled to the battery output via a charging power path.

13. The power delivery circuit of claim 9, wherein the intermediate bus converter is coupled to the system power input via a bypass power path.

14. The power delivery circuit of claim 9, wherein the charger controller is a hybrid power buck-boost (HPBB) charger.

15. The power delivery circuit of claim 14, wherein the HPBB charger is to operate in a narrow voltage direct charger mode.

16. The power delivery circuit of claim 9, wherein the adapter output is one of an extended power range output or a standard power range output.

17. A method comprising:
varying, by an intermediate bus converter, a voltage level of a system power input based on a battery output, wherein the intermediate bus converter is coupled to an external adapter output, the system power input and the battery output; and
connecting, by a charger controller, the battery output to the system power input whenever a voltage level of the system power input falls below a voltage level of the battery output.

18. The method of claim 17, wherein the voltage level of the system power input is one or more of a percentage value or an absolute value greater than a voltage level of the battery output.

19. The method of claim 17, wherein the charger controller is coupled to the battery output via a charging power path.

20. The method of claim 17, wherein the intermediate bus converter is coupled to the system power input via a bypass power path.

21. The method of claim 17, further including operating the charger controller in a narrow voltage direct charger mode, wherein the charger controller is a hybrid power buck-boost (HPBB) charger.
